(19) United States
(12) Patent Application Publication
(10) Pub. No.: US 2013/0068622 A1
(43) Pub. Date: Mar. 21, 2013

(54) Method and apparatus for real-time monitoring of droplet composition in microfluidic devices

(71) Applicants: Michael John Schertzer, Milton (CA); Ridha Ben Mrad, Toronto (CA); Pierre Edward Sullivan, Toronto (CA)

(72) Inventors: Michael John Schertzer, Milton (CA); Ridha Ben Mrad, Toronto (CA); Pierre Edward Sullivan, Toronto (CA)

(21) Appl. No.: 13/300,754

(22) Filed: Nov. 21, 2011

Related U.S. Application Data
(60) Provisional application No. 61/417,186, filed on Nov. 24, 2010.

(51) Int. Cl. G01N 27/04

(52) U.S. Cl. CPC G01N 27/04
USPC 204/600; 422/82.02

(57) ABSTRACT

A device for real time monitoring of fluid composition in microfluidic devices. The invention can be integrated into any microfluidic device where fluid moves along a pathway with a measurement region consisting of at least two measurement electrodes. The fluidic pathway can contain an unbound droplet, a droplet confined in at least one aspect, or a continuous flow. The device also includes control circuitry connected to measurement electrodes that allows for the determination of the droplet composition by measuring at least one of capacitance, resistance, or impedance between said electrodes. This invention can (1) measure droplet composition, (2) compare composition against a known sample, (3) monitor droplet mixing, (4) control mixing to achieve specific mixing ratios, (5) measure the particle concentration within a droplet, (6) determine the position of particles in a droplet, and (7) monitor chemical reactions. These functions call all be performed in real time.

### BACKGROUND OF THE INVENTION

Droplet based microfluidic devices have recently been introduced as tools to increase throughput and reduce operating costs of biological protocols [i.e. 1-5]. Device platforms have been introduced to manipulate droplets by chemical [2], thermal [2], acoustic [3], and electrical [4] means. Electrowetting on dielectric (EWOD) is one promising droplet based microfluidic platform. These devices apply asymmetric electric fields to manipulate droplets with diameters on the order of 1-2 mm that are confined between parallel plates separated by 50-150 μm (˜40-500 mL) [4-6,8, P1, P2, P3]. These devices have demonstrated the ability to create, move, split, and mix droplets of fluid. They also have low power consumption, high reversibility, and wide applicability to different fluids [4-9]. A comprehensive review of these devices can be found in [10].

One of the proposed advantages of continuous and droplet based microfluidic systems, is the ability to increase throughput by automating protocols and running them in parallel. Monitoring these devices is often performed manually, but this task must be automated for practical applications. EWOD devices capable of sensing the size, temperature, and electrochemical properties with a variety of devices were discussed in [P4], and the integration of unspecified sensors into these devices was discussed in [P3].

Most systems for automated droplet control in microfluidic devices depend on either optical observation [11,12], or capacitance measurements [13-16]. A system that could produce complex droplet paths in an EWOD device by actuating multiple electrodes at variable voltages was simulated in [11]. The proposed design used an optical control system to monitor droplet motion. The high throughput demands of practical applications require the motion of a multitude of droplets on densely packaged chips. Optical access to each droplet in the device would be impractical in these cases, and visual tracking of a multitude of droplets simultaneously would likely be computationally expensive. The presence of a droplet at strategic locations can also be determined using the integrated thin-film photodetector presented in [12]. Implementing this method to track droplets at every addressable position on the device would significantly increase the fabrication requirements and the cost of the device. If the dielectric constant of the droplet differs from that of the surrounding medium, capacitance measurements can be used to determine the void fraction at each addressable location in an EWOD device [13-16]. Since each addressable location in these devices is essentially a parallel plate capacitor, droplets can be tracked anywhere in the device with no additional fabrication requirements.

One of the earliest investigations using capacitive detection of droplets in droplet based microfluidic devices was [17] which showed that capacitance measurements could detect the presence of droplets. This method has been used successfully to determine optimal usage of electrodes on EWOD devices [13,14] and to create droplets of uniform size [15,16,P5]. The measurement of droplet volume has been the primary use for capacitance sensors in droplet based microfluidic devices [i.e. P6, P12]. Volumetric measurements have also been useful in the development of a pipette like droplet dispensation device [P2], and the creation and mixing of droplets in droplet based microfluidic devices [P5].

Knowledge of the composition of a droplet is important for many applications. The popularity of the use of particles in droplet based microfluidic devices is increasing rapidly [i.e. 25, P7-P11]. Real time composition measurements in these devices could be used to monitor the concentration and motion of particles. Such measurements could also be used to monitor process quality during the production of fluids. One such application would be to monitor the composition of fluids as they are mixed with dye to attain a specific color. In order to maximize throughput and minimize device complexity, it would be advantageous if these measurements could be made without requiring optical access to the chip, modification of the droplet, or additional fabrication.

Efficient fluid mixing is a common issue in microfluidic devices. On the microscale, Reynolds numbers are very low and viscous mixing dominates. Mixing in EWOD devices is commonly achieved through mixing in transport, or by moving droplets in a mixer along paths of varying complexity for a specified number of cycles [i.e. 18-20, P1]. The change in the real time composition of the droplets in these cases is generally monitored by incorporating a fluorescent signal in one of the species [18-20, P12], which requires optical access. Observations of droplet mixing in a pressure driven micromixer can be found in [21]. It has been proposed that fluid motion in EWOD devices can be enhanced and controlled by following more complex paths [i.e. 18,19] or imposing a time dependent rigid-body rotation [22]. It would be advantageous to be able to monitor droplet mixing without intrusive techniques or optical access to the device.

It has been shown that capacitance measurements can be used to achieve specific mixing ratios by mixing together droplets whose size was verified via capacitance measurements [16, P5]. In these instances, the measurements did not give real-time information about the state of droplet mixing because they could not provide information about the composition. Such information could minimize or eliminate the time the droplet spends within a droplet based mixer. This would lead to reduced cycle times and increased throughput. Real time monitoring of droplet mixing would also allow for the creation of specified mixing ratios from any two droplets, regardless of their initial size or composition.

It has been shown that capacitance measurements can be used as a means of providing real time information on the composition of a droplet in a droplet based microfluidic device [26]. This same technique was also used to monitor droplet mixing in real time on an electrowetting on dielectric device [26].

### REFERENCES

[1] Wheeler A. R., Moon H., Kim C. J., Loo J. A., Garell R. L., Electrowetting-Based Microfluidics for Analysis of Peptides and Proteins by Matrix-Assisted Laser Desorption/Ionization Mass Spectrometry. Analytical Chemistry, 76 (2004), 4833-4838.
[2] Brochard F., Motions of Droplets on Solid Surfaces Induced by Chemical or Thermal Gradients, Langmuir 1989, 5, 432-438
[3] Wixforth A., Strobl C., Gauer C., Toegl A., Scriba J., Guttenberg Z. v., Acoustic manipulation of small droplets, Anal Bioanal Chem, 2004, 379, 289-991.
[4] Washizu M., Electrostatic Actuation of Liquid Droplets for Microreactor Applications, IEEE Transactions on Industry Applications, 1998, v 34 n 4, 732-737.
[5] Cho S, Moon H, Kim C. J., Creating, Transporting, Cutting, and Merging Liquid Droplets by Electrowetting-Based Actuation for Digital Microfluidic Circuits, Journal of Microelectromechanical Systems, 12 (2003), 70-79.
[6] Ren H, Fair R, Pollack M, Shaughnessy E, Dynamics of electro-wetting droplet transport, Sensors and Actuators B 87 (2002) 201-206.
[7] Walker S. W., Shapiro B., Modeling the Fluid Dynamics of Electro-Wetting On Dielectric (EWOD), Journal of Microelectromechanical Systems, 2006, 986-1000.
[8] Chatterjee D., Hetayothin B., Wheeler A. R., King D., Garrell R. L., Droplet-based microfluidics with non-aqueous solvents and solutions, Lab on a Chip, 2006, 199-206.
[9] Jones T. B., On the relationship of Dielectrophoresis and Electrowetting, Langmuir, 2002, 4437-4443.
[10] Berthier J., Microdrops and Digital Microfluidics, William Andrew Pub. Norwich, N.Y., 2008.
[11] Walker S., Shapiro B., A control method for steering individual particles inside liquid droplets actuated by electrowetting, Lab on a chip, 2005, 1404-1407.
[12] Luan L., Evans R. D., Jokerst N. M., Fair R. B., Integrated Optical Sensor in a digital microfluidic platform, IEEE Sensors, 2008, 628-634.
[13] Su F., Ozev S., Chakrabarty K., Ensuring the operational health of droplet-based microelectrofluidic biosensor systems, IEEE Sensors Journal, 2005, 763-773.
[14] Su F., Ozev S., Chakrabarty K., Concurrent testing of digital microfluidics-based biochips, ACM Transactions on Design Automation of Electronic Systems, 2006, 442-464.
[15] Ren H., Fair R. B., Pollack M. G., Automated on-chip droplet dispensing with volume control by electro-wetting actuation and capacitance metering, Sensors and Actuators B, 2004, 319-327.
[16] Gong J., Kim C. J., All-electronic droplet generation on-chip with real-time feedback control for EWOD digital microfluidics, Lab on a Chip, 2008, 898-906.
[17] Pollack M, Electrowetting-based microactuation of droplets for digital microfluidics, Ph.D. Thesis, Duke University, North Carolina, 1999.
[18] Paik P., Pamula V. K., Fair R. B., Rapid droplet mixers for digital microfluidic systems, Lab on a Chip, 2003, 253-259.
[19] Fouillet Y., Jary D., Chabrol C., Claustre P., Peponnet C., Digital microfluidic design and optimization of classic and new fluidic functions for lab on a chip systems, Microfluidics and Nanofluidics, 2008, 159-165.
[20] Fowler J., Moon H., Kim C. J., Enhancement of mixing by droplet-based microfluidics, Technical Digest. MEMS 2002 IEEE International Conference. Fifteenth IEEE International Conference on Micro Electro Mechanical Systems (Cat. No. 02CH37266), p 97-100, 2002.
[21] Stone Z. B., Stone H. A., Imaging and quantifying mixing in a model droplet micromixer, Physics of Fluids, 2005, 1-11.
[22] Chabreyrie R., Vainchtein D., Chandre C., Singh P., Aubry N., Tailored mixing inside a translating droplet, Physical Review, 2008, 1-4
[23] Schertzer M. J., S. I. Gubarenko S. I., Ben Mrad R., Sullivan P. E.; An Empirically Validated Model of the Pressure within a Droplet Confined Between Plates at Equilibrium for Low Bond Numbers; Journal of Micromechanics and Microengineering {Submitted June 2009, EXIF-D-09-00169}
[24] Quinn A., Sedev R., Ralston J., Influence of the electric double layer in electrowetting, Journal of Physical Chemistry 107 (2003) 1163-1169.
[25] Sista R., Hua Z., Thwar P., Sudarsan A., Srinivasan V., Eckhardt A., Pollack M., Pamula V. Development of a digital microfluidic platform for point of care testing, Lab on a Chip, v. 8, 2008, v. 8, 2091-2104.
[26] Schertzer M. J., Ben Mrad R., Sullivan P. E., Using capacitance measurements in EWOD devices to identify fluid composition and control droplet mixing, Sensors & Actuators: B. Chemical, vol. 145, pp. 340-347, 2010.
[27] Elbuken C., Glawdel T., Chan D, Ren C. L., Real-time capacitive detection of microdroplets, Proceedings of the ASME 2010 International Mechanical Engineering Congress & Exposition, November 2010, Vancouver, BC, Canada. IMECE2010-37760 (2 pages).
[28] E. M. Miller, A. R. Wheeler, A Digital Microfluidic Approach to Homogeneous Enzyme Assays, Anal. Chem., 80 (2008), 1614-1619

### PATENTS AND PATENT APPLICATIONS REFERENCED

[P1] Pamula et al. 2005, Apparatus for Manipulating Droplets by Electrowetting-Based Techniques. U.S. Pat. No. 6,911,132 B2 Issued Jun. 28, 2005
[P2] Haluzak et al. 2006, Electro-wetting on dielectric for Pin-Style Fluid Delivery, U.S. Pat. No. 7,780,830 Issued Aug. 24, 2010
[P3] Takenaka et al. 2008, Actuator for Manipulation of Liquid Droplets, U.S. Pat. No. 7,735,967 B2 Issued Jun. 15, 2010
[P4] Pamula et al. 2007, Droplet Based Diagnostics, United States Patent Application 20,070,242,111 Issued Oct. 18, 2007
[P5] Kim et al. 2010, Method and Apparatus for Real-Time Feedback Control of Electrical Manipulation of Droplets on Chip. United States Patent Application 20,100,096,266 A1 Issued Apr. 22, 2010
[P6] Windolph, 2002, Process and Device for determining the volume of liquid droplets. U.S. Pat. No. 6,439,068 Issued Aug. 27, 2002
[P7] Pamula et al. 2008, Droplet Based Surface Modification and Washing. U.S. Pat. No. 7,439,014 Issued Oct. 21, 2008
[P8] Shah & Kim 2009, Method for Using Magnetic Particles in Droplet Microfluidics. United States Patent Application 20,090,283,407 Issued Nov. 19, 2009
[P9] Medoro et al. 2009, Method and Apparatus for the Manipulation and/or Detection of Particles. United States Patent Application 20,090,205,963 Issued Aug. 20, 2009
[P10] Kanagasabapathi et al. 2010, Integrated Microfluidic Transport and Sorting System. U.S. Pat. No. 7,658,829 Issued Feb. 9, 2010
[P11] Pollack et al. 2008, Droplet Based Particle Sorting United States Patent Application 20,080,053,205 Issued Mar. 6, 2008
[P12] Pamula et al. 2006, Apparatuses and methods for manipulating droplets on a printed circuit board, United States Patent Application, 20060194331, Issued Aug. 31, 2006

### BRIEF DESCRIPTION OF THE INVENTION

In one embodiment of the invention, a device for determining the composition of a droplet is made up of at least one droplet moving along fluidic pathway, and a measurement region consisting of at least two measurement electrodes. The fluidic pathway can contain a bounded droplet, an unbound droplet, or a droplet that is confined in at least one aspect. The device also includes control circuitry that is connected to the electrodes and allows for the determination of the droplet composition by measuring the capacitance between said electrodes. It should be understood that the device is not limited to two electrodes. For example, if the droplets were manipulated via electrowetting on dielectric then an array of electrodes is necessary to manipulate the droplets. In this case, the two measurements electrodes could be selected dynamically based on the position of the droplet so that the composition is continuously monitored as the droplet moves throughout the device. In one example of this invention, the electrodes are approximately the size of the droplet so that a global average of the droplet composition can be determined. In a second example, multiple measurement electrodes span at least one aspect of the droplet to give local information about droplet composition.

In a second embodiment of the invention, a device for determining the composition of a droplet is made up of at least one droplet moving along fluidic pathway, and a measurement region consisting of at least two measurement electrodes. The fluidic pathway can contain a bounded droplet, an unbound droplet, or a droplet that is confined in at least one aspect. The device also includes control circuitry that is connected to the electrodes and allows for the determination of the droplet composition by measuring the capacitance between said electrodes. This measurement can then be checked against a like measurement from a fluid of known composition held either on or off the microfluidic device. In one example of this invention, the electrodes are approximately the size of the droplet so that a global average of the droplet composition can be determined. In a second example, multiple measurement electrodes span at least one aspect of the droplet to give local information about droplet composition.

In a third embodiment of the invention, a device for determining change in the composition of a droplet is made up of at least one droplet moving along fluidic pathway, and a measurement region consisting of at least two measurement electrodes that are positioned in the section of the fluidic pathway where two or more droplets will be mixed. The fluidic pathway can contain a bounded droplet, an unbound droplet, or a droplet that is confined in at least one aspect. The device includes control circuitry that is connected to the electrodes and allows for the determination of the droplet composition by measuring the capacitance between said electrodes. It should be understood that the device is not limited to two electrodes. In the case of mixing, electrodes can line the entire mixing portion of the fluidic pathway so that composition of the droplet is measured continuously throughout the mixing process (FIG. 13, FIG. 19, FIG. 20). If this method is employed, measurements from various locations should be calibrated before comparing measurements from different locations. Physical understanding of the phenomenon and experimental results both suggest that the relationship between the measured capacitance and the droplet composition is approximately linear, so good accuracy can be had by comparing the measurements of two droplets of known composition at all measurement sites (FIG. 6, FIG. 7, FIG. 10, FIG. 11). In cases where the amalgamated droplet passes over a given portion of the mixing path multiple times, a single set of measurement electrodes could be used in this location to repeatedly monitor the droplet composition throughout the mixing process (FIG. 14). If only one measurement location is used, calibration of the measurement may not be necessary. In either case, the droplet would be fully mixed when the measurement (i.e. capacitance, resistance, impedance, etc.) reaches a steady state value. In one example of this invention, the electrodes are approximately the size of the droplet so that a global average of the droplet composition can be determined. In a second example, multiple measurement electrodes span at least one aspect of the droplet to give local information about droplet composition.

In a fourth embodiment of the invention, a device for determining change in the composition of a droplet is made up of at least one droplet moving along fluidic pathway, and a measurement region consisting of at least two measurement electrodes that are positioned in the section of the fluidic pathway where two droplets will be mixed. The fluidic pathway can contain a bounded droplet, an unbound droplet, or a droplet that is confined in at least one aspect. The device includes control circuitry that is connected to the electrodes and allows for the determination of the droplet composition by measuring the capacitance, resistance, or impedance between said electrodes. It should be understood that the device is not limited to two electrodes. In the case of mixing, droplets can line the entire mixing portion of the fluidic pathway so that composition of the droplet is measured continuously throughout the mixing process (FIG. 13, FIG. 19, FIG. 20). Measurements from a single, or multiple locations can be used to monitor the change in the composition of the droplet throughout mixing. Measurements should be calibrated when comparing values from multiple positions. In this embodiment, the composition can be monitored until it reaches some user defined value. At this point, the amalgamated can be separated into two droplets. Here, the composition of the two droplets is different at the end of the process so that at least one droplet achieves the user defined composition. In one example of this invention, the electrodes are approximately the size of the droplet so that a global average of the droplet composition can be determined. In a second example, multiple measurement electrodes span at least one aspect of the droplet to give local information about droplet composition.

In a fifth embodiment, the invention can be used to determine the presence and concentration of particles within a droplet in a microfluidic device (i.e. FIG. 16, FIG. 17). In this case, one or more droplets will again translate through microfluidic pathways on the device. The fluidic pathway can contain a bounded droplet, an unbound droplet, or a droplet that is confined in at least one aspect. The device also includes control circuitry that is connected to at least two measurement electrodes and allows for the determination of the presence and concentration of particles within the droplet by measuring the capacitance between said electrodes. This measurement can be used to determine the presence or concentration of particles in the droplet, or compared with a like measurement from a droplet with a known particle concentration held either on or off the microfluidic device. In one example of this invention, the electrodes are approximately the size of the droplet so that a global average of the particle concentration can be determined. In a second example, multiple measurement electrodes span at least one aspect of the droplet to give local information about droplet composition. In this manner, it would be possible to determine the global composition of the droplet as well as information pertaining to the location of particles within a droplet.

In a sixth embodiment, the invention can be used to monitor chemical reactions that occur within the droplet in real time (FIG. 19, FIG. 20). In this case, one or more droplets will again translate through microfluidic pathways on the device. Specific chemical reactions will occur within the droplet as it moves throughout the device (FIG. 20), or as it remains in a stationary position (FIG. 19). The fluidic pathway can contain a bounded droplet, an unbound droplet, or a droplet that is confined in at least one aspect. The device also includes control circuitry that is connected to at least two measurement electrodes and allows for measurement of the capacitance between said electrodes. Measurement data can be used to determine the composition of the droplet, or compared with a like measurement from a droplet with a known composition held either on or off the microfluidic device (FIG. 18). The measurement of composition in real time can indicate whether a chemical reaction is taking place, and to monitor the progress of that reaction. One example of this invention is to monitor the presence of a chemical reaction in an immunoassay to determine if a target protein is present in a biological sample. If the target is present, a chemical reaction takes place that produces particulate within the droplet when a reagent reacts with the secondary antibody. If the particulate has a dielectric constant that differs from that of the fluid in the device, the presence and concentration of the substrate can be detected using capacitance measurements.

### BRIEF DESCRIPTION OF THE FIGURES

FIG. 1 Sketch the invention with measurement electrodes aligned (a) in parallel and (b) on the same plane. In both cases, the capacitance between the two electrodes would be measured to determine the composition of the droplet.

FIG. 2 Sketch (a) of the experimental facility used in this investigation, and (b) a photograph of an example facility used in [26].

FIG. 3 Sketches showing a top down and vertical cross-section of droplets in the invention that are (a) totally confined, and confined on (b) one, (c) two, (d) three, (e) four, and (f) five sides.

FIG. 4 Sketch showing a top down and vertical cross-section of the invention with an unconfined droplet immersed in an immiscible fluid.

FIG. 5 Sketch an example electrowetting on dielectric device with an electrical diagram of the capacitance.

FIG. 6 Predicted difference in capacitance with a reference capacitance of Air (solid line), 75% Methanol (dashed line) and Water (dotted line).

FIG. 7 Average ΔC as a function of the Δ∈.

FIG. 8 Comparison of dimensionless capacitance and dielectric constants when F1 is water and an F2 is Air (solid line), Methanol (dashed line), and 75% Methanol (dotted line).

FIG. 9 Comparison of the measured values of C* with water as F1 and F2 as air (square), methanol (triangle) and 75% methanol (diamond). A solid line with a slope of 1 is given to show where C*=∈*.

FIG. 10 Distribution of capacitance measurements for (a) the population of three addressable locations (b) the first location, (c) the second location and (d) the third location. Also shown are the average of the population (solid line) and the averages of the individual locations (dashed lines).

FIG. 11 Comparison of the standard deviation of the measured data on each electrode and the standard deviation of the entire population both before (solid line) and after (dashed line) calibration for solutions with methanol concentration of (a) 0%, (b) 25%, (c) 50%, (d) 75%, and (e) 100%.

FIG. 12 Average ΔC as a function of droplet volume for water (triangle) and 75% methanol by volume (square).

FIG. 13 Dimensionless capacitance measurements from all electrodes during the mixing of water and 75% methanol (closed circle). Control cases of water (open circle), and 75% methanol (open square), and the expected capacitance (solid line) and the experimental resolution (dashed line) are also shown.

FIG. 14 (a) Dimensionless and (b) dimensional capacitance measurements from a single addressable electrode during the mixing of water and 75% methanol. Expected capacitance (solid line) and the experimental resolution (dashed line) are also shown.

FIG. 15 Experimental image of a particle carrying droplet in an EWOD device. The number of particles is determined through image analysis in MatLab.

FIG. 16 Experimental results showing the change in measured capacitance as a function of the number of particles present in the droplet.

FIG. 17 Experimental results showing the change in measured resistance as a function of the number of particles present in the droplet.

FIG. 18 Experimental results showing the difference in measured capacitance of mixtures from the average of the original reagents as a function of AP concentration.

FIG. 19 Change in dimensionless capacitance (C*) as a function of time for a stationary mixture of AP (2 μg/mL) and pNPP. Dashed lines indicate the values of C* for unmixed droplets of AP (−1) and pNPP (+1).

FIG. 20 Change in dimensionless capacitance (C*) as a function of actuation cycles for a dynamically mixed solution of AP (2 μg/mL) and pNPP. Dashed lines indicate the values of C* for unmixed droplets of AP (−1) and pNPP (+1).

### DETAILED DESCRIPTION OF THE FIGURES

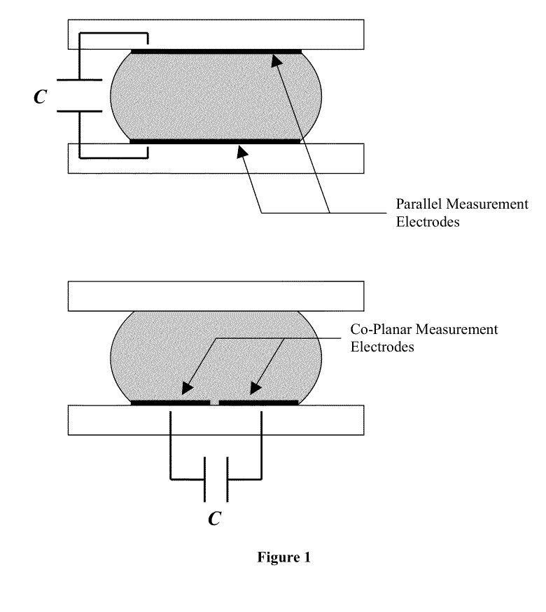

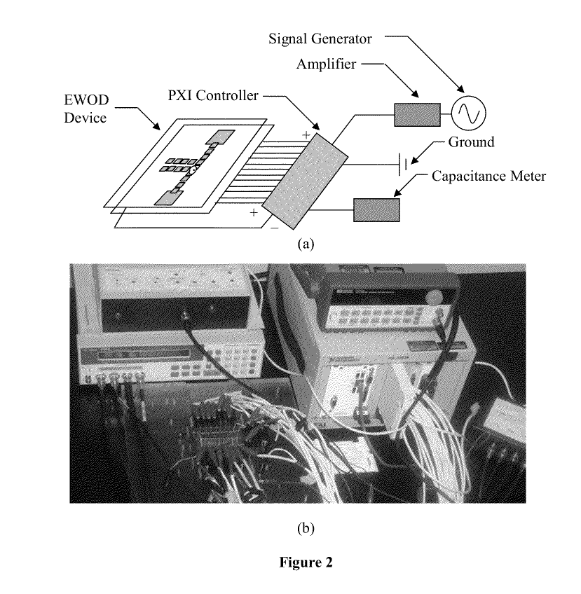

The invention described here can be used to provide real time information about the composition of droplets in microfluidic devices. This invention can be integrated into devices that drive droplets using a variety of actuation principles (i.e. pressure driven flows, electrowetting, electrowetting on dielectric, elecrohydrodynamic, surface acoustic wave, electroosmotic flow, and electrostatic flow). At least two measurement electrodes must be present in order for measurements to be taken in these devices. These electrodes can be oriented in parallel or coplanar and separated at a known distance (FIG. 1). Control circuitry in the device is connected to at least two measurement electrodes and allows for measurement of capacitance (or other property) between said electrodes (i.e. FIG. 2 a). If more than two electrodes are present in the device, this circuitry is programmed to take measurements at relevant electrodes at appropriate times. One example of such a system was shown in [26] with the implementation of a National Instruments PXI control system and an Agilent capacitance meter (FIG. 2 b). Another example uses off the shelf circuitry and a microcontroller [27]. Maximum resolution of capacitance measurements can be attained by having these electrodes in close proximity to the droplet, with the droplet covering as much area as possible on the electrode. Although capacitance measurements are most frequently discussed here, similar information could also be attained by measuring the fluid resistance, impedance, or other electrical property.

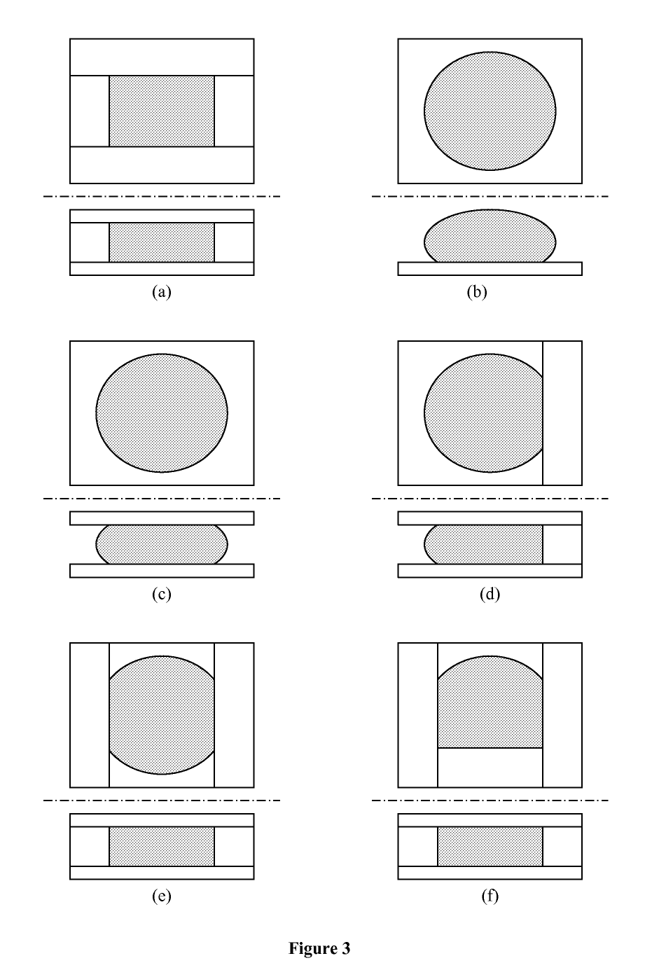

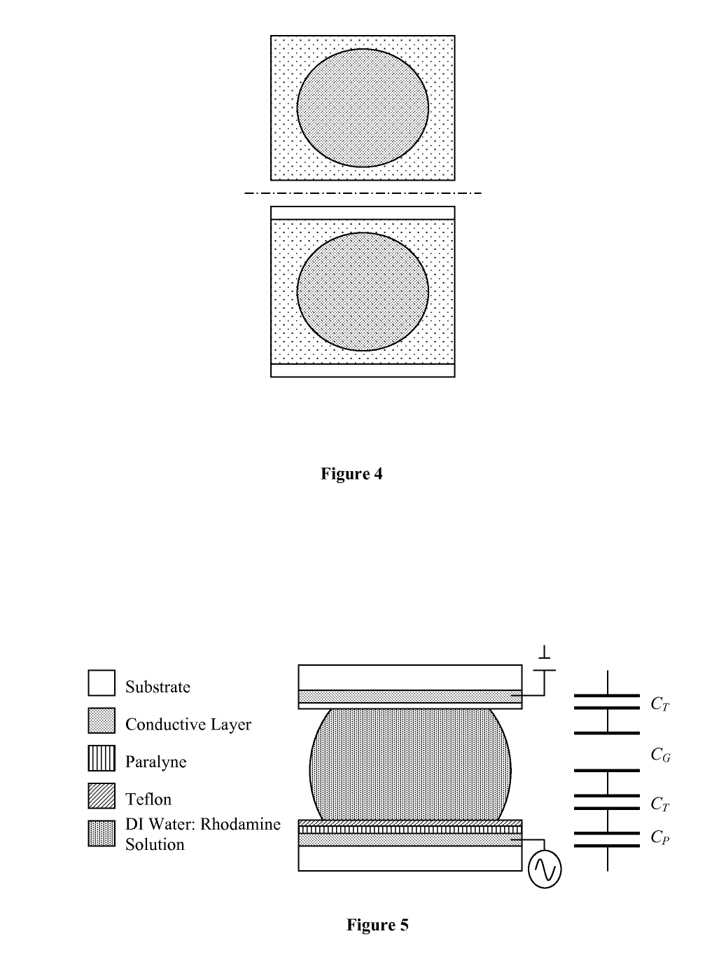

The invention can be used in microfluidic devices that totally confine a volume of fluid, or use channel-like fluidic pathways where the droplet is bounded on one, two, three, four, or five, sides (FIG. 3). The droplet can also be immersed in a stream of immiscible fluid so that is unconfined (FIG. 4) or confined in one of the manners shown in (FIG. 3). In some cases, the fluid stream and the droplets within may be driven via pressure forces. In all cases the medium surrounding the droplet can be an immiscible liquid (i.e. silicon oil), or a gas (i.e. air). In cases where the droplet is not immersed in an immiscible fluid, it may be advantageous to coat the substrates of the device in such a fluid to prevent contamination of the substrate.

One microfluidic platform that the invention can be easily integrated into is an electrowetting on dielectric device (EWOD). The parallel electrode design with separate addressable electrode positions found in these devices allows for the integration of capacitance measurements with little or no added device complexity. If each addressable position in an EWOD device is modeled as a number of parallel plate capacitors in series (FIG. 5), then the capacitance in each measurement volume is given by

$${C}_{Fi} = \frac{{ɛ}_{0} {ɛ}_{T} {ɛ}_{P} {ɛ}_{Fi} A}{{ɛ}_{Fi} ( 2 {ɛ}_{P} {t}_{T} + {ɛ}_{T} {t}_{P} ) + {ɛ}_{T} {ɛ}_{P} {t}_{G}} , \qquad ( 1 )$$

where ∈₀ is the permittivity of free space, ∈ is a dielectric constant, A is the area of the electrode, t is the material thickness, and the subscripts T, P, G and Fi denote the Teflon layer, the Paralyne layer, the gap between the substrates, and the fluid in the measurement volume respectively. In order to understand how capacitance measurements in EWOD devices change with droplet composition, it is useful to derive the difference between two capacitance measurements. Using (1), it can be shown that the difference between the capacitance and a reference capacitance is

$$\begin{matrix}{C}_{F 1} - {C}_{F 2} = \frac{{ɛ}_{0} A}{{t}_{G}} β ( {ɛ}_{F 1} - {ɛ}_{F 2} ) , where & ( 2 ) \\ β = \frac{1}{\begin{matrix}\frac{4 {ɛ}_{F 1} {ɛ}_{F 2}}{{ɛ}_{T}^{2}} \frac{{t}_{T}^{2}}{{t}_{G}^{2}} + \frac{4 {ɛ}_{F 1} {ɛ}_{F 2}}{{ɛ}_{P} {ɛ}_{T}} \frac{{t}_{T} {t}_{P}}{{t}_{G}^{2}} + \frac{4 {ɛ}_{F 1} {ɛ}_{F 2}}{{ɛ}_{P}^{2}} \frac{{t}_{P}^{2}}{{t}_{G}^{2}} + \\ \frac{2 ( {ɛ}_{F 1} + {ɛ}_{F 2} )}{{ɛ}_{T}} \frac{{t}_{T}}{{t}_{G}} + \frac{( {ɛ}_{F 1} + {ɛ}_{F 2} )}{{ɛ}_{P}} \frac{{t}_{P}}{{t}_{G}} + 1\end{matrix}} , & ( 3 )\end{matrix}$$

and the subscripts F1 and F2 denote the fluid being examined and a reference fluid, respectively. As the fluid within the measurement volume (F1) changes, ∈_{F1} changes as well. Since ∈_{F1} exists in β, it introduces non-linearity into (2). An order of magnitude analysis can be used to understand the extent of this non-linearity. In most cases, ∈_{F1} and ∈_{F2} will be an order of magnitude larger than ∈_{P} and ∈_{T} (Table 1). In the devices tested here, t_{G} was four orders of magnitude greater than t_{T} and two order of magnitude greater than t_{P} (Table 1). The highest order term in the denominator of β is 1. If terms in the denominator of β smaller than 10⁻² are neglected, then

$$β \approx \frac{1}{\frac{{ɛ}_{F 1} {ɛ}_{F 2}}{{ɛ}_{P}^{2}} \frac{{t}_{P}^{2}}{{t}_{G}^{2}} + \frac{{ɛ}_{F 1} {ɛ}_{F 2}}{{ɛ}_{P}} \frac{{t}_{P}}{{t}_{G}} + 1} . \qquad ( 4 )$$

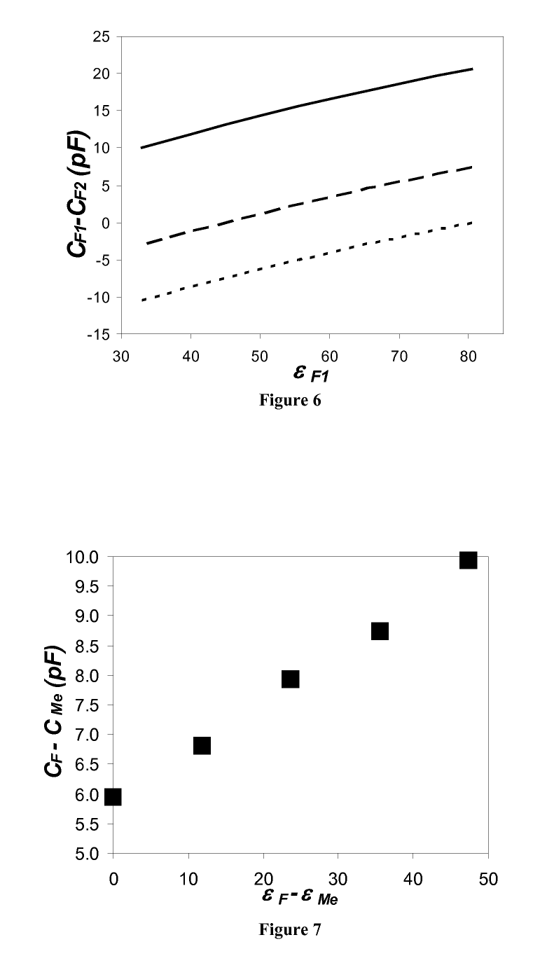

The predicted difference in capacitance is shown in FIG. 6 for reference capacitances of air (solid line), 75% methanol (dashed line), and water (dotted line). In all cases, the increase in the difference between the capacitance and the reference capacitance with ∈_{F1} is approximately linear. The slope of the three cases agrees to within 0.4%. This shows that the difference in capacitance is approximately linear in the range of interest in EWOD devices. An experimental result for a reference fluid of methanol also shows that the measured difference in capacitance is approximately linear (FIG. 7). It is important to realize that the value of β affects the sensitivity of C_{F1}−C_{F2}. For example, as t_{P}→0 then β→1 and C_{F1}−C_{F2}→∈₀A(∈_{F1}−∈_{F2})/t_{G}. Thus, the EWOD device can be designed to increase the sensitivity of capacitance measurements.

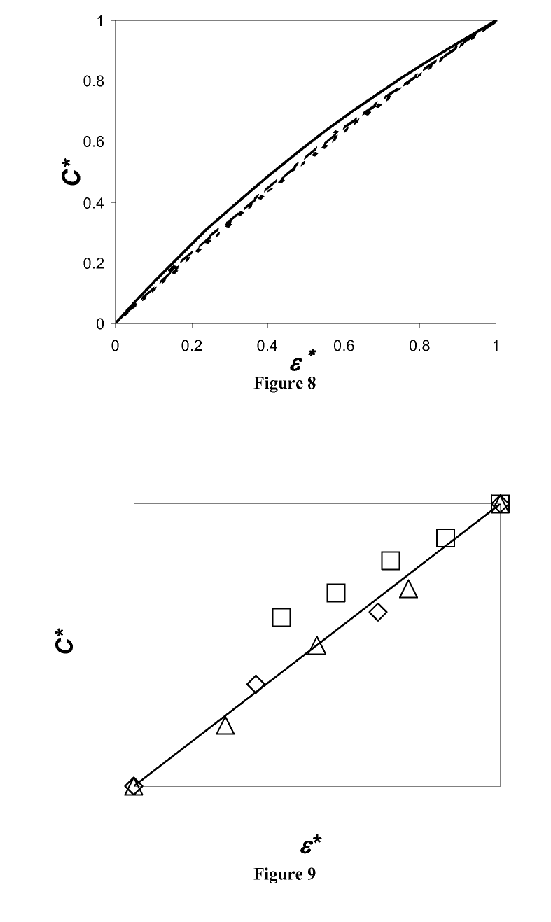

Since the difference in the capacitance is approximately linear with (∈_{F1}−∈_{F2}), the dimensionless capacitance C*=(C_{F}−C_{F2})/(C_{F1}−C_{F2}) is approximately equal to the dimensionless dielectric constant ∈*=(∈_{F}−∈_{F2})/(∈_{F1}−∈_{F2}). Here, the subscript F, refers to the fluid in the measurement volume and the subscripts F1, and F2, refer to two reference fluids respectively. This relationship is shown in FIG. 8. For the cases examined here F1 was always water and F2 was air (solid line), 75% methanol (dashed line), or water (dotted line). The difference between C* and ∈* decreases with (∈_{F1}−∈_{F2}) because the non-linearity in (2) decreases with (∈_{F1}−∈_{F2}). Therefore, the difference in the dielectric constants of the reference fluids should be minimized in order to identify fluids in EWOD devices. This result has also been examined experimental. As shown in FIG. 9, the experimental result becomes more linear as the dielectric constant of the reference fluid increases from air (square), to methanol (triangle), to 75% methanol (diamond). As such, the reference fluids should be those with the highest and lowest dielectric constants in an application. When water and methanol are used as the reference fluids, the value of C* differs from that of ∈* by an average of 3% and a maximum 5%.

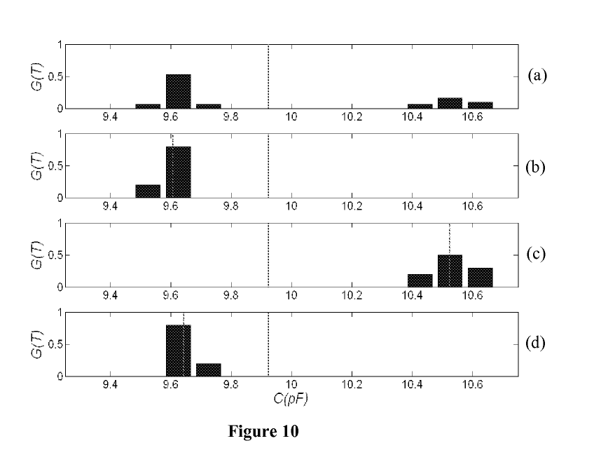

Multiple capacitance measurements for a water droplet actuated between three electrodes in an EWOD device were taken to confirm their repeatability; the distribution (G(T)) is shown in FIG. 10. Although the standard deviations in each measurement volume range between 0.05 and 0.08 pF, the standard deviation of the entire population is approximately 0.45 pF. This suggests that although the capacitance measurements are repeatable at every addressable location, measurement calibration is required in order to compare data from different locations.

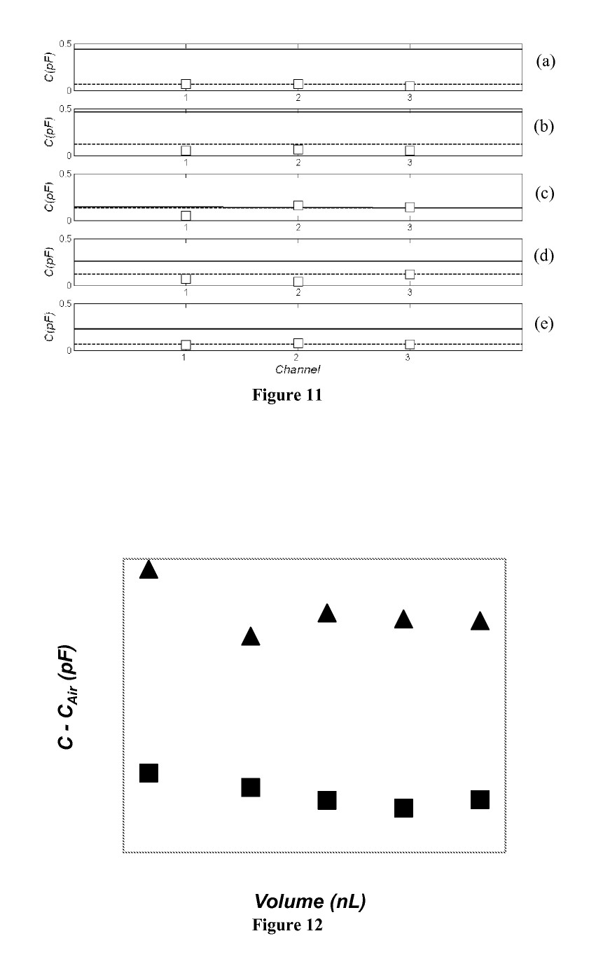

The type of calibration required can be determined by examining the measured capacitance as a function of the dielectric constant (FIG. 7). Here, each point on the curve is an average of 30 measurements distributed over three electrodes. As expected, the capacitance of the mixture increases linearly with ∈_{F}. The slope of the change in capacitance is approximately 0.08 pF for every unit change in the dielectric constant. This is approximately 0.04 pF per percentage decrease in methanol concentration. Since the change in capacitance is linear with concentration, the relative capacitance at each electrode was found using a two-point calibration. After performing the calibration, the standard deviation of the population of measurements for each solution was below 0.13 pF (FIG. 11). This is closer to the standard deviation on each channel and below the resolution of measurements. This suggests it is possible to identify the composition of solutions on EWOD devices and compare data from any addressable location.

Another possible issue with comparing capacitance measurements of droplets in EWOD devices is the effect that the droplet radius has on the measurements. As droplets move through EWOD devices, they are susceptible to evaporation. This will change their cross-sectional area and could affect the capacitance measurements. The droplet radius was varied between 650 and 1300 mL in this investigation. Water and 75% methanol droplets of various volumes were actuated back and forth over four electrodes a total of 40 times. The average capacitance for each radius was found to agree with the average of the total population to within 5% (FIG. 12). The droplet radius has little effect on the capacitance measurements because the capacitance measurement is a function of the area of the electrode so long as the droplet fills the entire measurement volume.

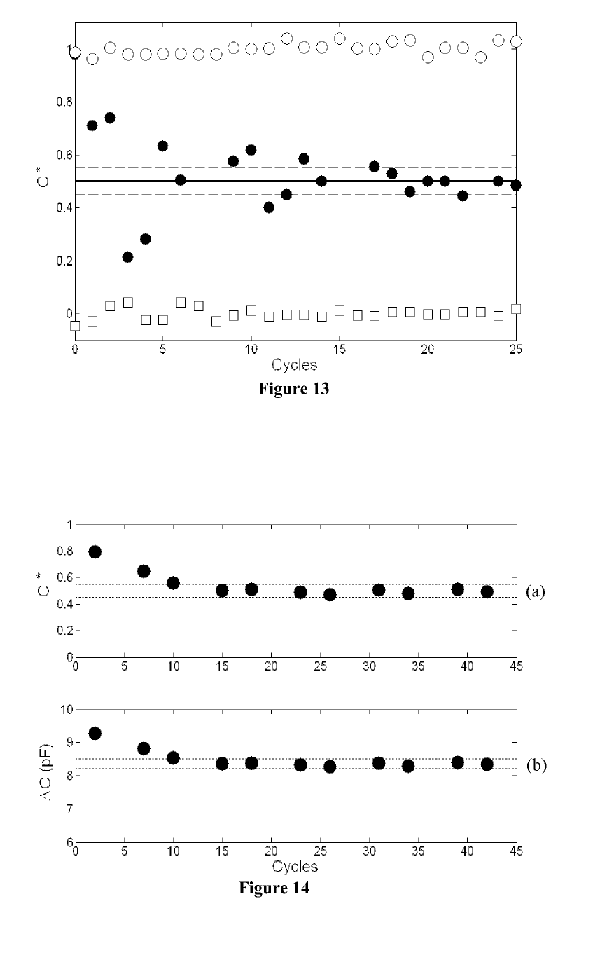

The change in dimensionless capacitance C*=(C−C_{Me75})/(C_{W}−C_{Me75}) during the mixing of water and 75% methanol droplets is shown in FIG. 13. Here, the closed circles represent the capacitance measurements taken as the two droplets were mixed together. The open circles and open squares represent control measurements taken for droplets of deionized water and 75% methanol, respectively. The expected capacitance of the fully mixed solution is represented by the solid line (C*=0.5), and the experimental resolution is shown by the dashed lines. Data for the motion of 1300 mL droplets of water and 75% methanol are also provided to show that the value in these control cases does not change due to a change in droplet volume, or a buildup in charge at the interface. Initially, the capacitance measurements in the mixed droplet range between the capacitance of water and the 75% methanol solution. As the droplets are mixed, the capacitance approaches the expected capacitance of a 37.5% methanol solution. This steady state measurement is indicative of a fully mixed droplet. Since the capacitance for all electrodes converges in FIG. 13, mixing can be monitored in EWOD devices by measuring the capacitance at a single location along the mixing path.

The dimensionless capacitance for a single electrode is shown in FIG. 14 (a). Here, the closed circles represent the capacitance measurements taken as the two droplets were mixed together. The expected capacitance of the fully mixed solution is represented by the solid line (C*=0.5), and the experimental resolution is shown by the dashed lines. The capacitance is initially close to that of water and approaches a steady state value over time. If a single electrode is being used, uncalibrated data could monitor droplet mixing. Typical uncalibrated mixing data for a single location is shown in FIG. 14 (b). Here, the closed circles represent the capacitance measurements taken as the two droplets were mixed together. The expected capacitance of the fully mixed solution is represented by the solid line (C*=0.5), and the experimental resolution is shown by the dashed lines. The first capacitance measurement from this electrode is approximately 9.3 pF and oscillates about 8.35 pF once mixing is completed. Eliminating the calibration decreases cycle time; however, more motion cycles are necessary to ensure complete mixing, as the target capacitance is unknown.

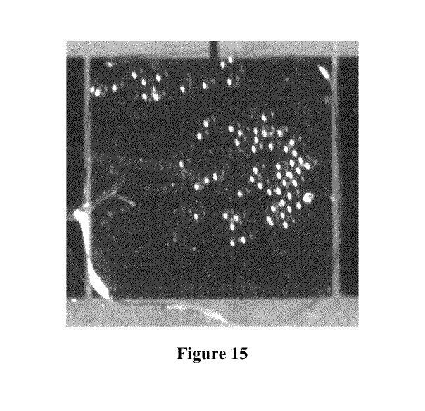

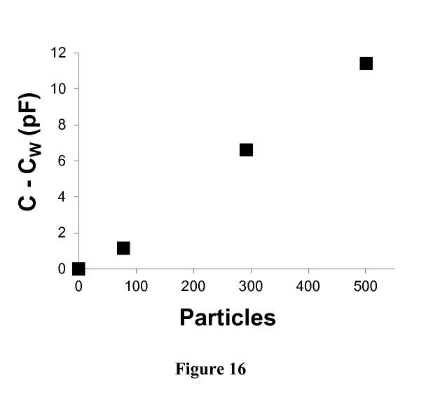

Capacitance measurements were taken as particle laden droplets with various concentrations were moved through an EWOD device. The number of particles in a measurement volume was determined by optically analyzing experimental images in Matlab (FIG. 15). The difference between the capacitance of the droplet and that of a droplet of DI water was found to increase monotonically with particle concentration (FIG. 16). The increase was approximately linear, with a rate of 23.3 fF per particle. Since the experimental resolution in these experiments was 0.2 pF, the maximum resolution of a capacitance measurement of a particle laden droplet is approximately nine particles. The experimental resolution is a reasonable measure of the accuracy in these experiments as the standard deviation of ten consecutive measurements was 0.15 pF.

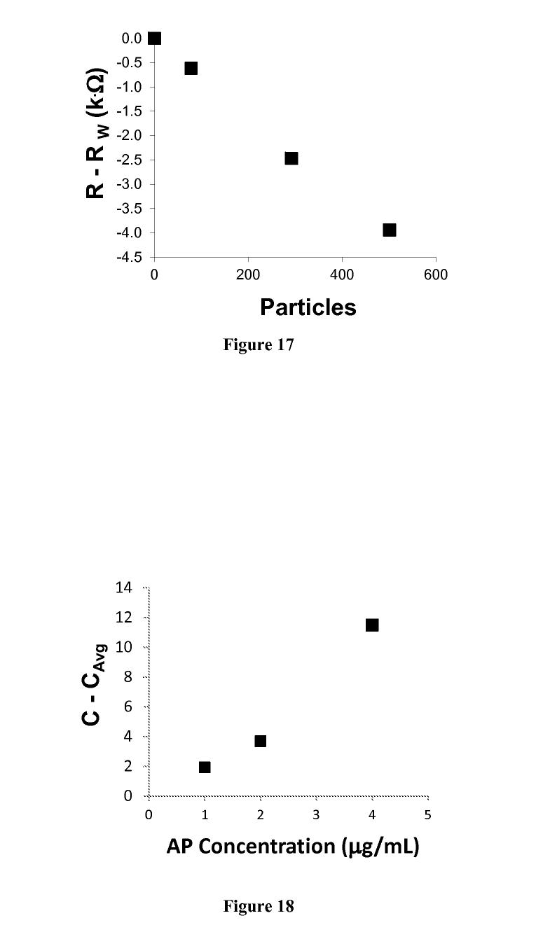

The resistance of particle laden droplets was compared to that of water for the same droplets where capacitance measurements were recorded (FIG. 17). The negative values of resistance here are a result of measuring an ΔC resistance in a capacitor. In these cases, the current leads the voltage, which yields a negative resistance by definition. The resistance decreased linearly with particle concentration at a rate of 8Ω per particle. In these cases, the experimental resolution (30Ω) is less than the standard deviation of the measurements (60Ω). As such, the standard deviation was used to determine that the resolution of resistance measurements was approximately eight particles. The data presented in FIGS. 16 and 17 shows that both capacitance and resistance measurements can determine particle concentration in EWOD devices with similar accuracy.

The ability of capacitance measurements to monitor chemical reactions was examined using mixtures of alkaline phosphatase (AP) and p-Nitrophenyl Phosphate (pNPP). The capacitance of premixed solutions was compared to the average capacitance of the unmixed reagents in FIG. 18. As shown in [26], subtracting capacitance values for EWOD devices can help determine the dielectric coefficient of the droplet. The non-linearity introduced by the polymer layers in the device is small compared to the change in the capacitance measurement and the capacitance of water-methanol solutions was found to be equal to the weighted average of the original reagents [26]. In the cases examined here, the difference between the measured and expected capacitance increased from 1.9 to 11.5 pF as the AP concentration increased from 1 to 4 μg/mL; corresponding to a change of 9.7 to 58 times the experimental resolution. The increased capacitance in these experiments is due to the chemical reaction in the droplet. As the reagent concentrations increase, the chemical reaction in the droplet yields more coloured precipitate which increases the deviation from the average capacitance of the original reagents. The increase in capacitance with increased precipitate concentration is consistent with the results using soda-lime glass spheres. This suggests that the measured capacitance of a mixed solution can determine the concentration of the original reagents. In an EWOD based immunoassay device, this information would be used to determine the concentration of secondary antibodies, and therefore target protein, in a sample.

The dimensionless capacitance (C*=(C−C_{F2})/(C_{F1}−C_{F2})) is approximately equal to the dimensionless dielectric coefficient (∈*=(∈−∈_{F2})/(∈_{F1}−∈_{F2})) in the measurement volume of an EWOD device [26]. Here, the subscripts F1 and F2 denote reference fluids that are suitable for the given measurement. In [26], the reference fluids were chosen to be the fluids in the investigation with the highest and lowest dielectric constant. It was found that the capacitance of two inert fluids was the average of the initial values (C* was bounded by 0 and 1 with a steady state value of 0.5). In the current investigation, the steady state value of chemically reactive fluids deviates from the average of the initial values. A change of scaling in the definition of C* was introduced where F1 and F2 denote the fluid with the highest dielectric constant and a hypothetical fluid with a dielectric constant equal to the average of the initial reagents. If applied to the inert case, C* would now range between −1 and +1, with a steady state value of 0. In the case of a chemical reaction, the steady state value of C* is the dimensionless difference between the actual and expected steady state values.

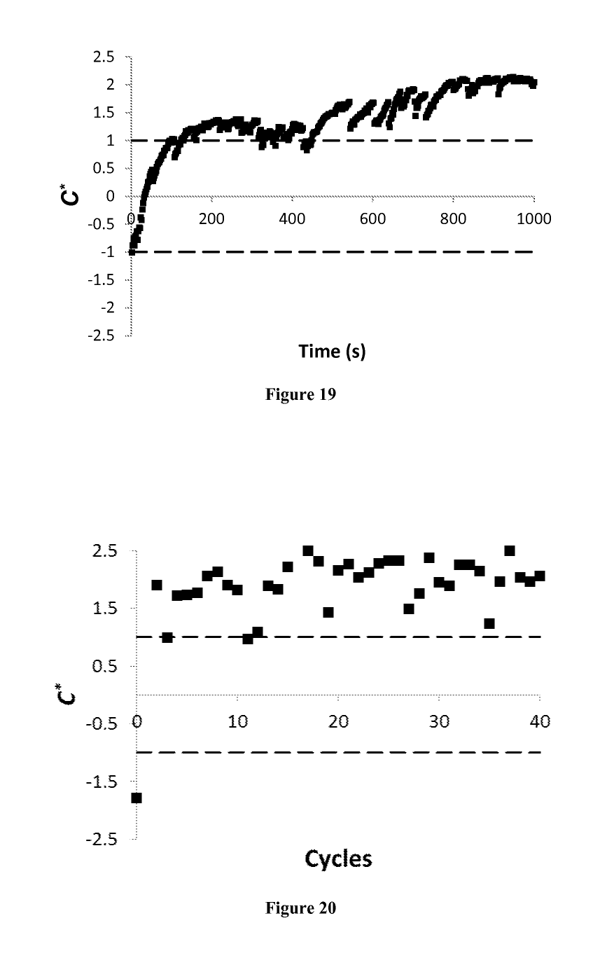

The real time change in dimensionless capacitance as a function of time for a stationary mixture of 2 μg/mL solution of AP and pNPP is shown in FIG. 19. In this case, droplets of each reagent were merged on a single electrode and the capacitance of the stationary droplet was recorded every 2 s without further manipulation. Initially, the capacitance of the mixture was approximately equal to that of the AP solution. In this case, the droplet of AP moved to fill the measurement volume faster than the droplet of pNPP. The capacitance increases steadily for the first 100 seconds, passing C*=0 at t=34 s and C*=1 at t=96 s. Droplet mixing is partly responsible for this increase. As the droplets merge, a mixed region of fluid fills the measurement volume. If this were the only mechanism responsible for the increased capacitance, C* should approach zero. Instead, C*→1 as t→100 s due to the chemical reaction taking place in the droplet. From FIG. 7, it is clear that the rate at which C* increases slows for t>100 s. Interestingly, the increase in C* is not monotonic from 100 s≦t≦800 s. Instead, the value gradually increases in cyclical bursts over time. From 800<t<1000 s, the dimensionless capacitance reaches a steady state value of 2.0 and a standard deviation of 0.1. This suggests that the fluid in the measurement volume has reached chemical equilibrium. Furthermore, the steady state and expected values differ by almost 42 times the experimental resolution. This demonstrates that capacitance measurements can provide real time feedback on the progress of chemical reactions in EWOD devices.

After tracking the progress of a chemical reaction in a stationary droplet, an experiment was performed where droplets of AP and pNPP were mixed in a four electrode linear mixer (FIG. 20). The initial measurement is approximately that of the AP solution. However, after a single cycle the dimensionless capacitance was greater than that of pNPP. There are two reasons for this dramatic increase. In the initial state, a droplet of AP solution is above the first electrode and a droplet of pNPP straddles the second and third electrodes. When the second electrode is activated, it is expected that there will be more pNPP than AP in the measurement volume so the measurement should be closer to that of pNPP. As the droplets merge, the chemical reaction takes place immediately which accounts for the increase in capacitance above the value of pNPP. As the amalgamated droplet moves through the device, the surface area of the reagent interface increases rapidly leading to a rapid chemical reaction in the droplet. After approximately 24 cycles, the dimensionless capacitance reaches a steady state. The average value from 24-40 cycles is again 2.0, with a standard deviation of 0.3. The increase in the standard deviation is the result of measurements being compared over multiple electrodes. The number of cycles required for steady state seen here is not unexpected. For inert mixtures, [26] reported that steady state was reached in 15 cycles and an increased number of cycles would be expected to reach chemical equilibrium in this case. It was also found that viable fluorescent measurements could be taken in EWOD immunoassays after 15 seconds of actuation in a 3×2 EWOD mixer [28]. The idle time between the cessation of droplet actuation and the fluorescent measurement was not provided. Although it has been shown that number of cycles (not mixing time) should be used to characterize mixing in EWOD devices [26], the average dimensionless capacitance after 15 s in the current investigation was 1.97 (39 times the resolution) with a minimum value of 0.97 (19 times the resolution). These results are similar to the fully mixed state. The results presented here suggest that capacitance measurements of chemical reactions in EWOD are comparable to fluorescent measurements. These measurements also have the potential to provide real time information for every addressable position on the device without the need for increased fabrication complexity or optical access.

What is claimed is:

1. A droplet based microfluidic device used for monitoring real time composition of droplets consisting of at least one droplet, at least one substrate and at least two measurement electrodes.
Examples of composition measurements include, but are not limited to the measurement of
Fluid concentration in the droplet.
Change in fluid composition during mixing of droplets.
Determining the presence or concentration of particles in the droplet.
Monitoring the progress of a chemical reaction in a droplet (i.e. change of composition, or generation of a chemical product).
Monitoring the progress of a physical change in a droplet (i.e. droplet changing from a liquid to a solid or a gas).

2. The device claimed in 1 where at least the measurement electrodes are
in direct contact with the droplets or
separated from the droplets by an immiscible fluid and/or
separated from the droplets by a dielectric layer and/or
separated from the droplets by a hydrophobic layer.

3. The device claimed in 2 where the measurement electrodes are either
larger than the droplet,
smaller than the droplet, or
of a size comparable to the droplet.

4. The device claimed in 3 where the droplets are manipulated using
Electrohydrodynamics
Electrostatic forces
Electrowetting on dielectric
Surface Accoustic Waves
Electro-osmotic flow
Pressure driven flow

5. The device claimed in 4 where the droplets are surrounded by at least one immiscible liquid or a gas.

6. The device claimed in 5 where the composition of the droplet is monitored by measuring capacitance, resistance, or impedance.

7. The device claimed in 6 where the measurement is taken while a droplet is in motion or while the droplet is at rest.

8. The device claimed in 7 that consists of a single substrate where measurement electrodes are arranged on the substrate in a co-planar fashion.

9. The device claimed in 7 where droplets are confined between two parallel substrates.

10. The device claimed in 9 where the measurement electrodes are arranged on one substrate in a co-planar fashion.

11. The device claimed in 9 where the measurement electrodes are oriented in parallel on both substrates.

12. The device claimed in 9 where the measurement electrodes are arranged in parallel on both substrates and or in a co-planar fashion on at least one substrate.

13. The device claimed in 7 where droplets are surrounded in an immiscible medium between two parallel substrates but remain unconfined.

14. The device claimed in 13 where the measurement electrodes are arranged on one substrate in a co-planar fashion.

15. The device claimed in 13 where the measurement electrodes are oriented in parallel on both substrates.

16. The device claimed in 13 where the measurement electrodes exist in parallel on both substrates and or in a co-planar fashion on at least one substrate.
